(19) United States
(12) Patent Application Publication
(10) Pub. No.: US 2002/0093466 A1
(43) Pub. Date: Jul. 18, 2002

(54) Head mounted optical device designed to provide a pilot with primary flight display image

(76) Inventor: Oded Ben-Arie, Bal Harbour, FL (US)

Correspondence Address: Allen M. Krass, GIFFORD, KRASS, GROH, SPRINKLE,, ANDERSON & CITKOWSKI P.C., 280 N. Old Woodward, Suite 400, Birmigham, MI, 48009, US

(21) Appl. No.: 10/027,094

(22) Filed: Dec. 20, 2001

Related U.S. Application Data
(60) Provisional application No. 60/257,914, filed on Dec. 21, 2000.

(51) Int. Cl. G09G 3/36; G09G 5/00

(52) U.S. Cl. 345/7

(57) ABSTRACT

To provide aircraft pilots with the information related to the airplane's operation which is incorporated in a Primary Flight Display, without requiring the pilot to interrupt his view out the windshield, as it would be required if the pilot observed the instrument panel, the pilot is provided with a clip-on display that can be attached to eyeglasses or sunglasses and will provide an image in front of the pilot in the field of sight and at an infinite distance. The display is derived from the standard electronic Flight Instrument System outlet port on the instrument panel and is processed by a computer so as to provide an appropriate display to the pilot.

### RELATED APPLICATIONS

This application claims the benefit of Provisional Patent Application Serial No. 60/257,914, filed Dec. 21, 2000, which is hereby incorporated by reference.

### FIELD OF THE INVENTION

This invention relates to heads up displays for aircraft pilots and more particularly to Primary Flight Display.

### BACKGROUND OF THE INVENTION

Heads-up displays were originally developed, for jet fighter aircraft, as a single object project—namely to substitute the mechanical cross hairs of the older fighters' ordnance system, with an optical device that delivers the accuracy needed for the much faster jet aircraft. The mechanical “bulls eye” was replaced with a clear glass screen, upon which the optical aim was projected in the line of sight between the pilot and the windscreen.

The advantages of these optical devices were soon realized and the next generation of jets were developed to include more data projected on the screen for the pilot's benefit. This data included critical flight information such as airspeed, altitude, navigation, direction, etc. Having all this data, practically on his windscreen, relieved the pilots from the need to keep their head down during critical phases of flight, when all of their attention should be focused outside. An example of such a situation is a landing approach, in instrument conditions. During an instrument approach, pilots must concentrate on their gauges in order to keep the aircraft on course, absent visual clues. However, upon transition into the final approach segment, pilots must divert their attention outside, through the windshield, in order to capture the first glimpse of the runway so they can land. In low weather this is practically impossible for a single pilot and very demanding even on a multi person flight crew. (Airlines' flight crews deal with this challenge by having the “pilot flying” (“PF”) concentrate on instrument flying only, while the “pilot non flying” (“PNF”) is looking outside for the airport). Projecting all necessary information in front of the pilot's windscreen, provides the pilot with the ability to look outside for the airport while still maintaining the critical instrument scan for flight safety.

As this technology was made available, outside the military, the heads-up display system migrated to civil aviation and became part and parcel of many flight operations where this system provides the answer to complex aviation needs. For instance, in less developed areas, where airfields lack modem and expensive navigational aids for landing purposes, this technology is officially authorized by the F.A.A. to reduce flight limitations. In lieu of I.L.S. (“Instrument Landing System”), ALASKA AIRLINES is authorized to shoot landing approaches with a H.U.D. system thus enabling it to provide scheduled service in areas where inclement weather prevails most of the year.

The problem with the existing H.U.D. equipment is its complexity and cost. Installation of such equipment, on airlines transport category aircraft, such as Boeing products, used by Alaska Airlines, makes economical sense. However, placing it in small, general aviation aircraft is not feasible, especially when it comes to the private sector of general aviation. Thus, the people who need this system the most, single pilots operating into smaller, less equipped airports, are deprived of the H.U.D. system benefits.

The high costs of H.U.D. equipment are associated with the challenges of clear projection of different instruments on a clear glass screen in front of the windshield in such a way as not to obstruct the pilot's flight visibility. The present invention takes advantage of new miniature technology, which can capture a big image and display it on a miniature eyepiece in the pilot's field of sight. This enables the elimination of the entire installation inside the cockpit. By interfacing this new miniature technology with yet another new advent which made its way into general aviation lately, it is possible to have the low cost, personal, portable heads-up display device carried by pilots in their eyeglass pouch and used in many different airplanes without being hard-wired into any one of these airplanes.

The other advent is the availability of “glass cockpit” to general aviation aircraft. Practically all new aircraft, coming into the market today, are manufactured with standard “electronic Flight Instrument System” (“EFIS”) display. Along with the new electronic display, came a newer version of flight symbology allowing engineers and instrument designers to assemble one major flight instrument which compiles almost all the necessary information in one efficient screen called “PFD” or “Primary Flight Display”. This new technology is moving even to older, existing, aircraft by special modifications, removing older instruments and replacing them with “EFIS”.

### SUMMARY OF THE INVENTION

The present invention moves the “PFD”, via electronic interface, from the “EFIS”, in the instrument panel, into the pilot's personal “HUD” linked to his flight glasses and in his field of sight, no matter in which direction he is looking. This interface became achievable due to the nature of the new “EFIS”. Unlike the old flight “steam gauges”, which were a bunch of different instruments, each one with its own scales and dials, knobs, and pushbuttons, the new EFIS “PFD” is one homogenized instrument, displaying invariably all the pilot's needs to know on one compact display. This new technology includes one additional feature making it available for our interface. This feature is the Data Output Port, designed originally for maintenance purposes. This port provides the technicians with a connection through which the aircraft computer can communicate with ground based support computers in order to solve problems and enable updates.

The object of this invention is to utilize the output from the data port by linking it into the pilot's portable computer for any processing and from there into the personal H.U.D. The additional processing may be needed to filter essential signals as well as to provide the ability to link the personal H.U.D. to many different aircraft flown by this one pilot.

The standardization of the new electronic flight instrument systems in the modem aircraft allows the pilot to carry a portable computer wired into his personal headmount portable display into any aircraft he intends to fly. Upon settling down in the flight deck, the pilot connects his portable computer to the output data-port, in the aircraft, puts his flight glasses on and by this “upgrades” his flying experience to the level enjoyed today only by pilots of the most sophisticated military equipment or airline operations.

The personal heads up display brings the compact flight information picture right into the pilot's eye so that it “blends in” with his field of sight. All the information the pilot needs exist in this picture and the hands free availability combined with the heads up accessibility makes this technology a critical tool for flight operations described above.

The clip-on display includes a color “liquid crystal display” (“LCD”) built into an opto-mechanical system that clips onto a pair of ordinary eyeglasses or sunglasses. The image appears in front of the wearer in the field of sight and in an infinite distance so the pilot can maintain focus effortlessly.

### BRIEF DESCRIPTION OF THE DRAWING

FIG. 1 is an actual image of an existing flight display which is currently on the market and provides the layout of all the information captured by the invention and provided to the pilot's eyepiece.

FIG. 2 is an actual image of an existing eyepiece which can be used by the pilot to deliver the image to the pilot's eye.

FIG. 3 is a schematic drawing of the invention's link between the aircraft instrument panel data output port and the pilot's eyepiece.

### DETAILED DESCRIPTION OF THE PREFERRED EMBODIMENTS

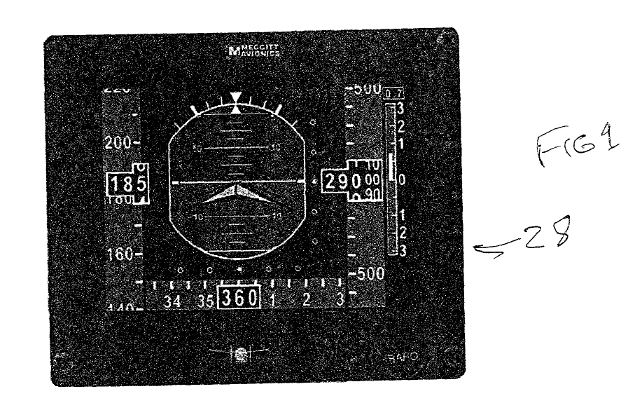

Referring to the drawings, FIG. 1 illustrates a Primary Flight Display, or “PFD”, which incorporates the display of all the major flight instruments normally incorporated in an aircraft such as airspeed, altitude, glide slope indicator, barometric setting as derived by the pilot from radio and entered into the system, compass heading, turn and bank indicator and landing heading. The information required to generate this display is available at the Electronic Flight Instrument System (“EFIS”) port on the instrument panel and is intended for use by technicians for maintenance purposes.

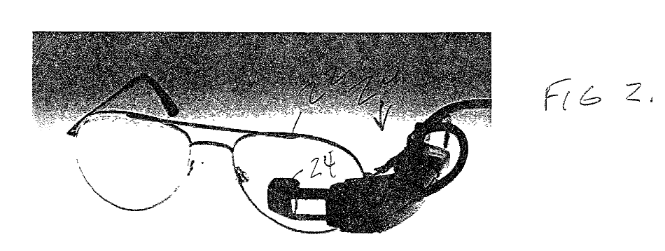

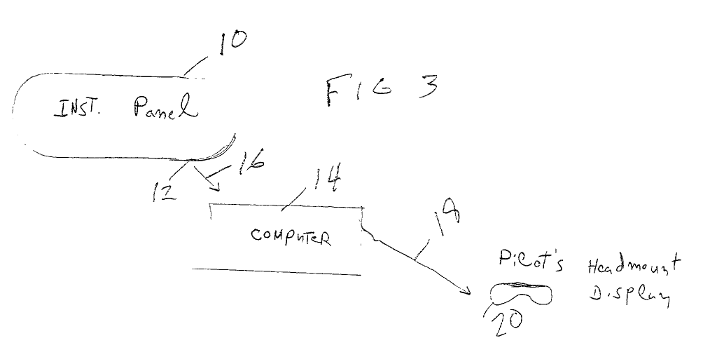

As illustrated in FIG. 3, an aircraft instrument panel 10 is provided with an EFIS data port 12. A computer 14 is connected to the port 12 by a line 16. The computer 14 contains a program which can process the instrument information provided over line 16 into the PFD format. The output of the computer, on line 18, is provided to the clip-on display, schematically illustrated as 20 in FIG. 3 and illustrated in detail in FIG. 2. This device preferable clips on to a standard pair of eyeglasses or sunglasses 22 and includes a display, preferably a liquid crystal display 24, which is disposed in the pilot's field of view. The image generated by the computer 14 is preferably focused at infinity so that the pilot can observe the data without refocusing his or her eyes, in the manner of a head up display. The display provided is of the type 28 illustrated in FIG. 1.

Having thus described my invention, I claim:

1. A system for providing a pilot with a display of primary flight instruments that can be viewed while the pilot's eyes are focused at infinity through the aircraft windshield, comprising:
a computer;
means for connecting the computer to an electronic flight instrument system data output port on the aircraft's instrument panel; and an eyeglass mounted, clip-on, display operative to receive the output of the computer,
the computer being operative to process the information from the electronic flight instrument system outlet port into a single display which incorporates outputs from all of the principal flight instruments.

2. The system of claim 1 wherein the display is in the form of a primary flight display.

3. The system of claim wherein the eyeglass mounted display constitutes a liquid crystal display.
